(19) United States
(12) Patent Application Publication
(10) Pub. No.: US 2016/0132811 A1
(43) Pub. Date: May 12, 2016

(54) Influential Peers

(71) Applicants: Ali DAVAR, Vancouver (CA); David Robert THOMPSON, Vancouver (CA); Maziyar HAMDI, Vancouver (CA)

(72) Inventors: Ali DAVAR, Vancouver (CA); David Robert THOMPSON, Vancouver (CA); Maziyar HAMDI, Vancouver (CA)

(73) Assignee: 0934781 B.C. Ltd, Vancouver (CA)

(21) Appl. No.: 14/690,325

(22) Filed: Apr. 17, 2015

Related U.S. Application Data
(63) Continuation-in-part of application No. 14/537,092, filed on Nov. 10, 2014.
(60) Provisional application No. 62/082,088, filed on Nov. 19, 2014.
(60) Provisional application No. 62/082,076, filed on Nov. 19, 2014.
(60) Provisional application No. 62/126,372, filed on Feb. 27, 2015.

(51) Int. Cl. G06Q 10/06; G06F 17/30

(52) U.S. Cl. CPC G06Q 10/06393; G06F 17/30442; G06F 17/3053

(57) ABSTRACT

A computer method and system provide means for identifying influential organizations in a business network. The system comprises a database of business relationships between organizations. The system applies algorithms to determine which organizations are influential to others. In response to a user searching for a product, service or organization, the system determines which product, service or organization are recorded in the database as connected to an influential organization.

### RELATED APPLICATIONS

This application claims the benefit of: U.S. patent application Ser. No. 14/537,092 filed Nov. 10, 2014, entitled “Recommendation Engine”; U.S. Patent Provisional Application Nos. 62/082,088 and 62/082,076, both filed on Nov. 19, 2014, both entitled “Business Relationship Accessing”; and Patent Provisional Application No U.S. 62/126,372, entitled “Product or Service Recommendation”. The contents and disclosure of the above are incorporated herein by reference in their entirety.

### TECHNICAL FIELD

The present disclosure relates to methods for operating a system and database of business relationships between organizations. Certain methods are useful for selecting, processing and outputting relationship data, particularly data that is relevant to a particular product or service of an organization. The system may comprise a computer network accessible via the Internet.

### BACKGROUND

There is a trend towards using Internet resources to make buying decisions for products and services. For example, Google and Bing provide general Internet search services, whilst TrustRadius, G2Crowd, and Findthecompany.com provide a service specifically for searching for a company or software. A prospective client may be looking for a law firm to handle a complicated merger or a factory to mass-produce their product. The choice of supplier requires careful consideration and buy-in from management.

Review websites provide expert or crowd-sourced opinions on products/services to help inform purchasing decisions. The review websites may include facts about companies in a database. In some instances, a list of companies is ranked according to a metric such as size or revenue of the company. In these cases, the user must judge what review or metric might be suitable for their own business.

Moreover, this does not help the searcher determine which potential supplier/investor/partner is the best or most relevant to themselves.

The inventors have appreciated that there is additional value to be gained by arranging a database as a network of business relationships. By calculating similarity between companies, even without a formal business relationship established therebetween, the system can improve its predictive and suggestive power to help the user. Influential companies can be determined to further strengthen these predictions and suggestions to users of the system.

### BRIEF SUMMARY OF THE INVENTION

According to a first aspect of the invention there is provided a computer implemented method for identifying an influential organization from a database of organizations. The method comprises: a processor receiving, from a database, attribute data of a target organization and attribute data of a second organization; a processor identifying one or more attributes for comparing organizations and identifying a direction of advance for each attribute; a processor applying an algorithm to determine that the second organization is an influential organization to the target organization if the attribute values of the second organization are more advanced than the attribute values of the target organization.

According to a second aspect of the invention there is provided a computer implemented method for identifying an influential organization from a database of organizations. The method comprises: retrieving historical attribute data of a target organization; retrieving historical attribute data of a second organization; identifying one or more attributes for comparing organizations and a direction of advance for each attribute; a processor applying a time-series analysis algorithm to determine that the second organization is an influential peer of the target organization if the historical attribute values of the second organization are similar but more advanced than the attribute values of the first organization.

The above aspects may be modified by the following features.

The method may further comprise repeating steps of the method for a plurality of second organizations to determine a set of second organizations that are influential to the target organization.

The method may identify the one or more attributes for comparison comprises determining an industry of the target organization and attributes for measuring organizations in the industry.

The target and second organization may be in the same industry.

The second organization may be determined not to be an influential organization if any of its attribute values are more advanced than a threshold amount compared to the target organization.

The algorithm may comprise extrapolating attribute values of the target organizations and calculating a distance from extrapolated attribute values to the second organization's attribute values.

The method may further comprise calculating an influence score of the second organization from a distance of the second organization's attribute values to the target organization's attribute values.

The method may further comprise calculating influence scores for the set of influential organizations and ranking them based on the influence scores.

The method may further comprise calculating advancement of organizations from a projection of their attribute values onto a pre-determined vector of advancement for an industry of the target organization.

The method may further comprise recording in the database whether the second organization is influential to the target organization.

The method may further comprise identifying first organizations having a business relationship in the database to the set of influential organizations and recommending at least one of the first organizations to a user.

The determination that a second organization is influential may further require that the second organization's attribute values were previously similar to the recent attribute values of the target organization and have subsequently advanced.

The method may further comprise calculating an influence score for the second organization based on an degree of similarity between the organizations' attribute data and a degree of advancement in the second organization's attribute values.

The period of the historical attribute data for comparison the depends on a user-query of a category of products or services, the period preferably being greater than 6 months ago or less than 2 years ago.

According to a third aspect of the invention there is provided a computer-implemented method for recommending organizations from a database of business relationships between organizations. The method comprises: a processor receiving a query for searching for first organizations on behalf of a target organization; a processor determining second organizations that are influential organizations to the target organization; a processor identifying first organizations from the database that match the query and have a business relationship in the database with at least one of the influential organizations; and a processor communicating data about the identified first organizations to a client-computing device.

According to a fourth aspect of the invention there is provided a computer-implemented method for recommending suppliers from a database of business relationships between organizations. The method comprises: identifying a set of suppliers satisfying a query and a set of clients; identifying attributes of the clients that can be affected by the suppliers and retrieving data for those attributes; estimating the effect that each supplier has on its clients' attributes; and recommending suppliers to a user based on their estimated effect.

Attributes that can be affected may be stored in a model of database and depend on a category defined by the suppliers.

The attributes may be success factors for measuring success of clients in a given industry.

The method may estimate the effect on attributes of all clients by a given supplier.

The method may estimate the effect on attributes of a selected client by a supplier category defined by the suppliers.

The method may predict the effect on attributes of a target organization by one of the suppliers or a supplier category defined by the suppliers.

Recommending suppliers may be based on their predicted effect on attributes of a target organization.

The clients are preferably recorded or calculated to be influential to the target.

It is therefore possible to identify a set of organizations that are influential to a target organization and useful in making further recommendations.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

The invention may be illustrated by the following figures, in which like reference numerals refer to similar elements.

FIG. 1 is a diagram of agents for processing data and interacting between a client device and server.

FIG. 2 shows three geometric representations for determining influential peers

FIG. 3 is a table of attributes for measuring vendor performance.

FIG. 4 is a table of stages and events for an organization.

FIG. 5 is a table of attributes for measuring client performance.

FIG. 6 is a graph of revenue over time for similar organizations.

FIG. 7 is graph of performance for similar organizations and their suppliers.

FIG. 8 is a diagram of connected data objects in a database.

FIG. 9 is a flowchart for identifying and ranking suppliers.

FIG. 10 is a webpage showing recommendations based on influential organizations.

### DETAILED DESCRIPTION

A system comprising a network, database and computer program(s) are implemented to capture business relationships between organizations. The system may be utilized to provide personalized recommendations of organizations according to user-selected criteria, as discussed in co-pending application U.S. Ser. No. 14/537,092, entitled “Recommendation Engine”. The computer program may be conceptually divided into separate modules or agents to provide discreet functions, although in principle there is no boundary required to implement these functions.

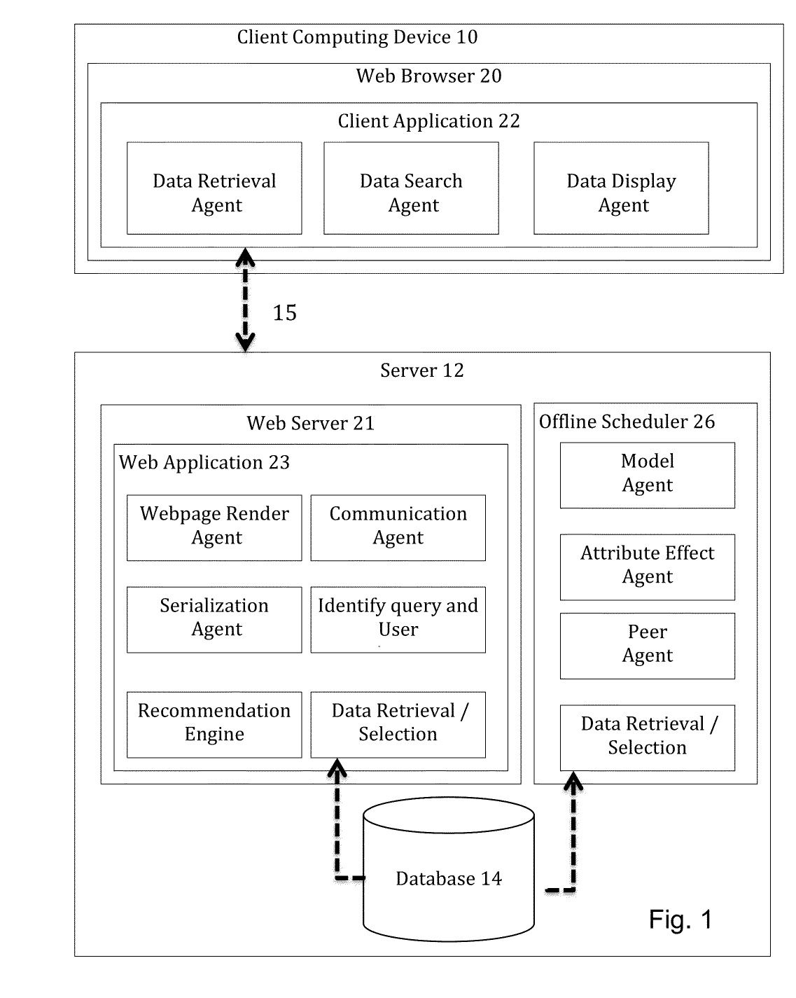

As shown in FIG. 1, the system may be implemented over a network between computing device(s) 10 and a server 12 for querying and receiving business data from a database 14. The server 12 may comprise one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving products or services. While an organization may typically be a business, the term includes but is not limited to charities, corporations, sole proprietors, Non-Government Organizations (NGO), institutions, government departments, and partnerships. The term supplier is used herein to refer to organizations that supply products or services in a business relationship, notwithstanding that they may also consume products or services in another relationship. A business relationship is used herein to refer to a business-to-business (B2B) relationship or commercial transactions between organizations to provide those products or services. Preferably the relationship represents an agreement, which, for example, may subsist in a contract, a terms-of-business document or an ongoing understanding. Most preferably the business relationships stored in the database represent relationships that have been ongoing for at least three months or have at least three repeat instances of transactions. This is in contrast to personal relationships, non-commercial relationships, click-thru data or user website activity data, or one-off commercial transactions. Therefore the strength of the present recommendation is derived from a deep tie between organizations, as recorded in the database. An ongoing, high-value relationship is used as a proxy to suggest that the products or services are of high-importance to an organization.

A target organization as used herein is an organization for which a recommendation is being made or personalized search query results are being retrieved. In one day, thousands of organizations may each be individually considered a target for which separate calculations are computed and personalized content generated. A target organization may be identified in real-time based on activities related to that organization and associated users.

A user is generally defined as a person who interacts with a computer, typically entering search criteria, following hyperlinks and viewing recommendations. A user is expected to be associated with, preferably employed by, the target organization. In some cases, the database and methods will be accessed by a computer bot for displaying a relevant organization to a target organization or associated user. For example, an ad-tech bot may determine, using cookies or viewed content, that a user is working in a particular industry or for a particular target organization. The ad-tech bot could display ads to the user, depending on what products and services are most relevant to the target organization.

FIG. 1 illustrates the interaction between a client computation device 10 and the server 12 over network link 15. The device 10 may communicate via a web browser 20 having an application layer 22, using software agents to search the database 14, retrieve output data and display the data on the user's device 10. The server 12 may be a reverse proxy server for an internal network, such that the client 10 communicates with an Nginx web server 21, which relays the client's request to associated server(s) and database(s) 14. Within the server(s) a web application 23 comprises software agents for operating with the database 14. Some software agents may operate as backend* processes to calculate scores and make recommendations.

Users may access the database 14 remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology.

The client device 10 may interact with the server using a web browser using conventional Internet protocols. The web server will use the serialization agent to convert the raw data into a format requested by the browser. Some or all of the methods for operating the database may reside on the server device. The client device 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device.

The methods and database discussed herein may be provided on a variety of computer system and are not inherently related to a particular computer apparatus, particular programming language, or particular database structure. In preferred embodiments the system is implemented on a server. The term ‘server’ as used herein refers to a system capable of storing data remotely from a user, processing data and providing access to a user across a network. The server may be a stand-alone computer, mainframe, a distributed network or part of a cloud-based server.

The database is arranged as a network of business relationships between organizations. Typically these relationships will be between a supplier and consumer of a product or service but other relationships may exists, such as investors, partners, subsidiaries . . . * It is likely that there is no formal business relationship between two companies in the same industry, as they likely supply the same products or operate at the same point in the supply chain. Therefore the network will have few relationships between similar companies entered by users. Unlike users of peer-to-peer social networks which accept suggestion to make a connection with similar people, users of the present system might not accept that a business relationship exists just because companies are similar.

However the inventors have appreciated the benefits of identifying links between companies that are similar. The system thus comprises a peer agent to calculate the similarity between organizations. This calculation may be done in real-time in response to a user action or done offline and stored in the database as a data object linking the organization data objects. This can be seen as creating an inferred relationship in the database, which increases connection density and allows greater analysis, modeling, data mining, and recommendations.

The peer agent preferably also determines whether one organization is an influential peer to another. As used herein, influential peers are organizations that will influence how a user will make a strategic business decision, by virtue of being better in a relevant respect than the user's organization (the target organization). Whilst the term ‘better’ is subjective, the system is arranged to store a direction of advancement or improvement in certain attributes.

The purpose of influential peers is to provide a computer with means to predict which organization might influence the behavior of another organizations, tighten the concept of peers, and predict the evolution of an organization.

Several methods for determining peers, influential peers and making recommendations of strategies, such as relationships to form, are described below.

In contrast to other social networks storing mutual, non-directional connections (friend-friend, associate-associate, classmate-classmate), the present database and system are arranged to record the nature of relationships and their direction, for example, to indicate the flow of products and services or which organization is influenced by which other organization. This enables the system to determine which organizations are supplies and which are consumers for a particular product or service or which organization will be influenced by business decisions of another.

The nature of the relationship may be described in general terms: peer-peer, influencer-influencee, leader-follower, supplier-client, provider-receiver, buyer-seller, supplier-customer; or in more specific terms: partners, client-advisor, manufacturer-assembler, designer-distributor-retailer, joint venture, client-service provider, investor-investee, parent-subsidiary. Alternative terms will occur to the skilled person as appropriate descriptions of a business relationship.

### Database Format

The database may be implemented in a variety of ways known within computing science, such as an object database, relational database or a graph database. Depending on the schema used, the data about an organization may be called an object, a record or a node. Generally these may each be called a ‘data collection’ to capture the concept of a group of data elements associated with an organization, product/service or relationship without reference to a specific data schema. The skilled person will appreciate that descriptions herein of processing organizations, products/service, and relationships refer to the data objects representing them, rather than the organizations, products/services, and relationships themselves.

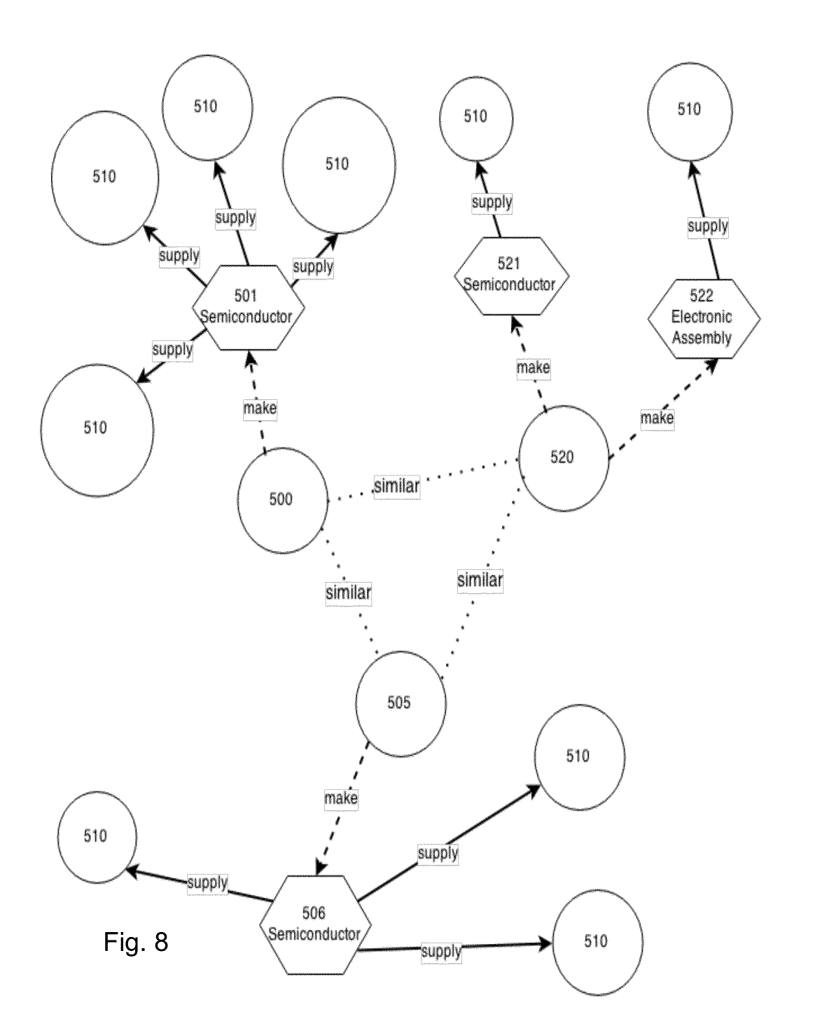

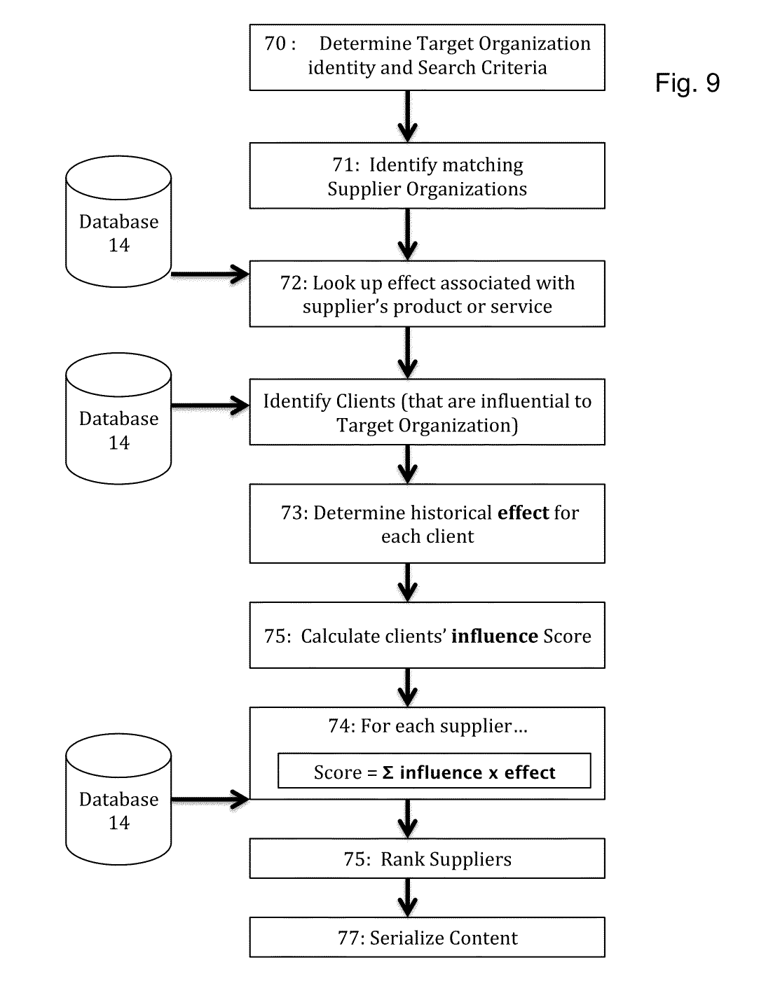

As conceptualized in FIG. 8, the database is structured to record a plurality of business relationships (solid lines), data about the relationships (such as the nature of the relationship, reviews and monetary values), attributes about the organizations 385, 395 (circles), and products/services 390 (hexagons) supplied or consumed by organizations. The database may also record similarity (dashed lines) between organizations.

In preferred embodiments, a graph database is used, wherein organizations and their products are stored as nodes and business relationships are stored as edges. This is illustrated in FIG. 8 by a solid arrow from a product node (hexagon) to a consumer node (circle); by a dashed arrow from a supplier node (circle) to a product node (hexagon); and a dotted line between similar organization nodes. An organization may be a supplier and a consumer, depending on the product or service in which they are dealing.

The graph comprises a first type of edge (relationship edge) between products and organizations defining how an organization deals with respect to a product; e.g. as a maker, assembler, buyer, etc. A relationship data object may comprise attribute data giving further details such as the time frames involved, investment amount, product type, sales amount, or terms of the contract, for example, “NY Biotech Ltd has purchased ABC Corp's reagents since 2008, on a non-exclusive basis” or “ABC Corp has sold reagents since 2004”. This attribute data provides the user with in-depth understanding of trends and significance of relationships.

The graph may comprise a second type of edge (similarity edge), which records the degree to which one organization is similar to another. The similarity edge may be bidirectional to indicate that two organizations are mutual peers or the edge may be unidirectional to indicate that one organization is considered similar to another organization but not vice versa, or at least not in the same way or degree. There may be more than one similarity edge between organizations to capture the different degrees or ways that two organizations are similarity.

Alternatively, the database may be a relational database wherein a relationship record comprises foreign keys pointing to an organization and a product or service. An organization's attribute data may be stored in the organization's record, which is stored in the organization table.

Data about a product or service supplied by an organization may be stored in a product/service table. A product record may include its product category, supply origin, brand name, model number and keywords. A company's service may be defined by its service category, office, specialism, and keywords.

Thus a complete relationship can be determined by collating data from relationship records, associated organizations records and associated product/service records.

The system stores data for organizations; products and services in the database and can find or compare product and services depending on the nature of the data. The data may be conceptually divided into different types:

Identification data enables the system to identify the organization, product or service. Identification data includes data such as legal name, parent company name, brand name, office address, IP address, logos, trademarks, or company registration number;

Attribute data describes properties of the organization, product and services using categories or values, but do not identify the organization. The attribute data may be sorted and classified according to a structure with defined terms. Attribute data includes classes and values such as industry, sector, general location, specialization, product category, service category, number of employees, market capitalization, field of practice, or revenue;

Business segment data is a subset of attribute data for describing the business function of an organization, product or service and includes classes such as industry, sector, specialization, product category, service category, or field of practice; and

Keyword data provide a collection of relevant words or terms, which are not necessarily organized in a structured way or having defined terms. These may be user enter keywords or machine learned keywords, for example derived using TFIDF. These keywords provide another way for the system to define and search for products and services, which enables the database to capture differentiation between competing products in the same category.

Attributes may be recorded as a time-series or as static values, preferably with a time stamp.

### Similarity

The personalization of the recommendation is based on determining what organizations are similar to or peers of the target organization. It is possible that some peers to one organization are not peers to all other members of that peer group or they may have additional peers not in that peer group. An organization that provides two distinct services will have two sets of peers, whereby members of each set may not consider the other set to be in their own peer group. A similarity metric may be calculated between every organization in the database. This is computationally expensive and so this calculation is preferably processed offline and stored as a data object in the database. Preferably the processor only creates similarity edges for similarity scores that are greater than a threshold score, so as to reduce the need to store data for minimally similar organizations.

In some cases, the target organization will not have been recorded in the database with similarity edges to any known peers. In this case, peer organizations are determined in real-time for the recommendation.

A similarity edge may comprise a value measuring the degree of similarity or relevance. Alternatively, similarity edges may be recorded as either TRUE or FALSE. The similarity edge may comprise a text or code indicating the nature of the similarity (e.g. “small biotech peers”, “large banks”, “subsidiaries of XYZ Corp”). The nature of the similarity may be output to a user to indicate how organizations are similar.

In preferred embodiments, similarity between two organizations is calculated using multiple algorithms, which consider different factors such as similarity of attribute data and co-occurrence in online media. The similarity and co-occurrence may be with respect to the organizations themselves or the products/services they supply. The scores from these algorithms are weighted and combined to reach a similarity value.

As used herein, the terms ‘similar’ and ‘peers’ are related. Organizations may be considered similar because they have many attributes in common. Peers are similar with the added provision that they are in the same or related industry/sector/specialism and/or offer related products or services. Thus two organizations that have similar attribute data for size, location, and age are considered similar but may not be considered peers if they have different business segment data such as industry or sector. Two organizations in the same industry are considered peers, and comparing attribute data, such as revenue, location, and specialism, can further refine the similarity score. The skilled person will appreciate there are many known algorithms to calculate similarity metrics and/or perform peer clustering using attribute data. For example, similarity metrics could be based on Jaccard similarity coefficients or cosine distance, and peers could be clustered using expectation maximization, hierarchical clustering or density-based clustering algorithms.

Alternatively or additionally, similarity can be determined by co-occurrence in online journals, blogs and social media. This can be done by searching for the names of two organizations or their products/services in the same individual blog, microblog or industry journal article. Co-occurrence can also be found by noting the frequency with which people view both organizations in a web session. The co-occurrence approach is inherently less quantifiable but has the advantage of crowdsourcing to determine which organizations are actually perceived as peers or similar.

Similarity between organizations may also be inferred from an analysis of social networks and social media by determining which employees of organizations are connected. This assumes that people that share similar profession interests or know each other might work for similar organizations. This assumption is truer for social contacts within professional networks and industry-specific media, particularly when several employees of one organization are connected to several employees of another organization. The peer agent employs bots to determine a connectedness score between organizations based on social inter-connectivity of their employees. The peer agent may further determine the industries of the organizations. The agent assigns this connectedness score to similarity if the organizations are in similar industries.

As discussed above, companies may be determined to similar or even peers by the similarity of their attribute data. The products/services of organizations may also be used to determine whether organizations are similar. Thus in preferred embodiments the peer agent of the system retrieves from the database records of products and services supplied by an organization and compares them to those of another.

The skilled person will appreciate that there are a multitude of technique to compare two sets of records to calculate an overall degree of similarity. For example, the agent may perform a pairwise comparison of products and services between each organization and sum the pairwise scores to determine the overall similarity of the organizations.

If keywords are used to define products, the peer agent may perform keyword matching between two products or cluster analysis between each organization's clusters of keywords.

Extending the use of the graph to determine similarity between organizations, the peer agent may determine whether they are suppliers to or clients of the same organization or to a plurality of organizations that are themselves similar. Thus following the network of organizations, such as a supply chain, the peer agent can use iterative and recursive algorithms to determine the connection similarity score of companies based on the similarity of companies to which they are connected.

Similarity of companies may be a directional metric in the sense that a large company may offer many of the products/services of a small company but also offers many other products/services, such that the large company does not consider the small company to be a significant peer. Thus the small company is either not a peer to the larger one or the similarity score is reduced in that direction. This consideration can be included by normalizing the product similarity score by the number of product/service of one of the companies to determine that company's perspective of the similarity to the other company.

As a numerical example, Company A has 10 products and Company B has 4 products. Two of the products match well giving a similarity score of 2. After normalization Company B views Company A as 50% similar (2 matches divided by 4 products) and Company A views Company B as 20% similar.

### Strength

The system may use algorithms to capture the concept of organizational goodness, advancement or strength in order to make a calculations and relative comparisons. The system may compute a strength score for an organizations from a) their attribute values, b) their connections in the database c) their products/service quality or popularity, d) their consumption of products/services and e) their presence in social media (Tweets, likes, shared links). This score may be stored with the organization data objects, optionally recording the score as it changes over time. The strength score may be a global score but preferably is at least partially dependent on the organization's industry, as not all industries measure strength in the same sense.

An algorithm for calculating the strength of an organization may include weights or coefficients for each attribute type. For example, the algorithm may be arranged to weight revenue more than web traffic or vice versa. The weighting may depend on the industry and stage of the organizations concerned.

For example, in the social media industry, revenue and web traffic might outweigh the number of offices a company has. Even so, web traffic might outweigh revenue for start-up social media companies, which then becomes reversed for large media companies.

In some embodiments, the system comprises a model agent to create a model of how attribute importance varies across industries, size and maturity levels, such that the weight used to measure strength could vary based on the industry, size and maturity level of the organization concerned. There are many ways to build such a model. For example the model may a) use historical data in a regression to fit a regression model based on historical data to predict directions and rates of advancement in attributes, b) employ heuristic rules from industry experts or c) be a look-up-table (LUT). The model will determine the magnitude of advancement for an organization and direction of advancement for each attribute, as some attributes have negative associations (debt, accidents, recalls, delays). More details are provided below of illustrations of such models.

The attributes compared may be one or more of several standard attributes recorded for all organizations in the database or industry-specific attributes. In FIG. 5, a LUT is created that records the attribute(s) that are important factors for certain industries.

For each factor, a data source is identified and either stored in the system's database or pointed to by a link recorded in the system. The data source may be publicly available records, analysts' reports, industry journals, or organization web sites. The data maybe retrieved offline, in a batch process and recorded in the relevant organization data object. The data stored may be the most recent value or a set of historical data.

In an alternative embodiment, each organization data object comprises fields to store attribute types that are important to that organization. This is useful to record important attributes that are particular to the organization and not sufficiently covered by the important attributes for their industry. Optionally a user may input the attribute(s) for their associated organization through a user-interface.

Preferably the strength algorithm uses attribute types that have directional values and preferably continuous values. Useful attribute types for comparison include: employee count, financial data (revenue, sales, growth), product/services sales, awards, sentiment, tweets, mentions in online media, age, investment stage, size of clients, market capital, number of offices, number of storefronts, product marketshare, awards, Alexa™ score, passengers. Negatively associated attributes such as debt, lawsuits, product recalls, accidents may be handled by using an appropriate negative weighting, inverting the value or expressing the attribute as a positively associated ratio, e.g. equity-debt ratio (instead of debt-equity ratio), time between accidents, or products per recall.

Attributes such as recognition and reputation may be used if a reliable source of such data is available. Nominal attributes such as location, industry, product and services names are preferably not used in comparing companies, unless a score can be assigned to each individual value.

Attributes are termed directional if advancement of an organization can be expressed as a function of the attribute value. For simplicity, the function is preferably monotonic increasing or decreasing and linear over the range being considered but this is not necessary; a local advancement optimum being an example of a non-linear, non-monotonic function.

The direction of advancement may be manually entered and stored in the system's memory. The direction may also be determined thru machine-learning using existing attribute values of organizations. Attribute direction of advancement may be found from attributes of organizations, which are manually labeled from less to more advanced. Using machine-learning techniques and statistical tools such as regression, neural nets, and Principle Component Analysis, the model determines the attributes that contribute most to the concept of advancement and determines the weightings of those attributes. Preferably the model comprises attributes that are independent from each other, statistically significant and ****. Using time-series data the machine-learning algorithm can determine how attributes change over time, assuming that attributes improve over time. Moreover the algorithm can determine an industry's average amount of advancement in an attribute per unit of time.

The problem with machine-learning on certain attributes is that bigger companies will naturally tend to appear worse such as having more accidents and lawsuits and lower profit margins, which does not capture the expected direction of advancement. One solution can be to express an advancement attribute as a ratio of attributes such that the ratio improves over time or with better organizations.

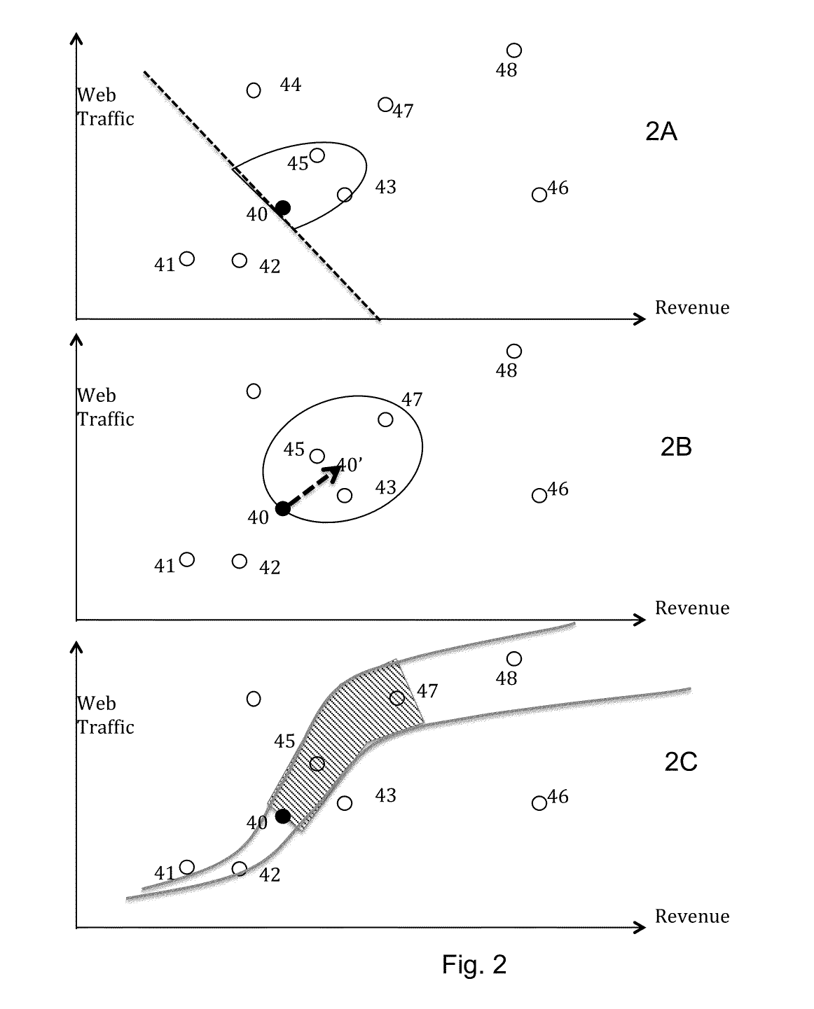

FIG. 2C shows a pair of curves fitted from a regression on attribute data of organizations in a given industry to determine how the attribute values change as an organization matures, whereby the pair of curves represents a distribution of expected growth, described by a Gaussian process. The model may be a linear regression, a non-linear regression, or a neural net fed with many years worth of data, from many attributes, for hundreds of organizations in that industry. The model is then able to determine the sensitivity to and direction of growth for any attribute in time. The result may be a series of equations of attribute in (relative) time:

Revenue=F(t); Web=G(t); Employees=H(t) Eq. 1

Then for a given target organization, its present (and possibly past) attribute values are fed into the model to project an expected improvement in the attributes. In FIG. 2C, the target organization's present attributes are low revenue and medium web traffic and the model indicates that it should experience moderate revenue growth and high web traffic growth. Optionally, the time parameter may be eliminated by expressing one attribute in terms of another, e.g. how revenue increases as a function of employees or web traffic as shown in FIG. 2C.

The system may determine a vector of advancement comprising a plurality of attributes and a weighted direction of advancement in each attribute. The system can then project a vector of an organization's attribute values onto the vector of advancement, whereby the magnitude of the projection is a measure of the strength of the organization.

As discussed above, the attributes that are success factors and their weights may be taken from a look-up-table (LUT) such as FIG. 5. The industry-dependent attributes may be weighted and combined with the industry-independent attributes from the machine model to compute a strength score or an influence score. For example, revenue might always be considered important but less so than the industry-dependent attributes.

The LUT approach is time-intensive to create and maintain over time but is computationally simple and ensures that an excessive number of noisy, unimportant factors are not brought into the model thru a machine learning process. There may be several thousand industries listed, which means determining thousands of key factors and a data source for each. However, once these are determined, calculating a relative strength score simply requires identifying the target's industry, looking up the industry's three success factors in the industry LUT and each organization's values for the factors in the organization data object, and compare the organization's attribute values.

### Influence

The strength score may be used, in an absolute sense, to recommend the most advanced organization or the one that has business relationships with the most, strong organizations.

In a relative sense, the strength score may be used to compare organizations. Two companies may be similar but one company more advanced in some respect and is thus termed an “influential” peer of the another, but not necessarily vice versa. Thus from the strength score, one company may be determined to be an influential peer of another if a) they have greater values for certain attributes (higher revenue, more employees), b) they have more connections in the relationship database, c) they offer more products/services or greater sales of products/services in a similar product/service category, d) they consume more products/services in a similar product/service category or e) they have a greater presence in social media.

In FIG. 5, up to three success factors (attributes) are listed for each industry. The units of attributes are completely different so an advancement is determined in relative terms. For example, two mining companies may differ by millions of tonnes of extracted ore and just a few accidents, but expressed as a percent change the accidents may represent a much bigger difference.

As an example, the relative strength R_strength_{P-T} of a peer P to the target organization T may be determined by:

$${R\_Strength}_{P - T} = \frac{A 1 ( P )}{A 1 ( T )} \times \frac{A 2 ( P )}{A 2 ( T )} \times \frac{A 3 ( P )}{A 3 ( T )} \qquad Eq . 2$$

where A1( ), A2( ), and A3( ) are the target or peer's values for the three attributes, whereby a relative strength greater than 1.0 may identify an influential peer. This example equation captures the net improvement of the peer over the target, as a ratio, from three attributes in orthogonal dimensions. Thus if the peer is 10% better in each dimension, they are 33.1% better overall.

The relative strength is preferably calculated as a weighted sum of attributes, which captures the differing importance of attributes and does not assume that the attributes are orthogonal. *Is this the Manhattan distance? Dave*

$${R\_Strength}_{P - T} = {W}_{1} \times \frac{A 1 ( P )}{A 1 ( T )} + {W}_{2} \times \frac{A 2 ( P )}{A 2 ( T )} + … + {W}_{n} \times \frac{An ( P )}{An ( T )} \qquad Eq 3$$

where A1( ), A2( ), and A3( ) are the target or peer's values for the three attributes, Ws are the attributes weights, whereby a strength greater than the sum of the weights alone represents an influential peer.

Most preferably, the relative strength is calculated using a sum of squares distance formula.

$${R\_Strength}_{P - T} = \sqrt{{( \frac{A 1 ( P ) - A 1 ( T )}{W 1} )}^{2} + {( \frac{A 2 ( P ) - A 2 ( T )}{W 2} )}^{2} + … + {( \frac{A 1 ( P ) - A 1 ( T )}{W {n}_{ }} )}^{2}} \qquad Eq 4$$

The comparison of organizations based on their attributes may be made in a number of ways. The system may compare the absolute strengths of each organization based on the vector of advancement discussed above. Therefore influential organizations will have more advanced attribute values and also aligned with norms for the industry. An organizations is calculated and recorded to be influential to a target organization simply if its strength (magnitude projected along the vector of advancement) is greater than the strength of the target organization.

Thus both the target and influential organization are measured against the industry's measure of advancement. A modification of this algorithm is to offset the vector of advancement so that it passes through the target's attribute values, such that organizations are deemed influential if the projection of their attributes on this offset vector makes them more advanced than the target.

Alternatively an organization is influential to the target if their attribute values are more advanced relative to the attribute values of the target and within an inclusion area. The charts of FIG. 2 illustrate a plurality of organizations 40-48 plotted in two attribute dimensions (web traffic and revenue). Rules may be established to set an inclusion area relative to the target for defining that an organization is influential to the target 40. This area may be a regular or irregular shape and/or defined by a set of minimum and maximum limits. The minimum limit ensures that organizations that are similar but in some regard less advanced than the target are not included. The optional maximum limit stops organizations that are much more advanced from being included.

The limits will depend on the rules deemed appropriate by the system administrators. Preferably the minimums for each attribute are set to the values of the target, or as shown in FIG. 2A the minimum is defined as a dotted line in the two attribute dimensions (or a plane in three dimensions). Preferably the maximum for each attributes are predefined multiples of the target's attribute values, or as shown in FIG. 2A is defined by a semi-sphere (or semi-ellipse). In FIG. 2A only organizations 43, 45 are determined to be influential to organization 40.

The system may optionally extrapolate a target organization's value forward in the direction of advancement. This sets a new locus of attribute values 40′ from which influential peers are considered. The system determines the new locus using the model of advancement for that industry over a time period relevant to the business decision to be considered. For example, the system may be ranking companies to work with the target or recommending infrastructure changes, for which the system uses a six month and 2 year period, respectively, to determine the target's future attribute values and nearest peers. The rank of companies or recommendations thus depends on what the target's future peers are doing right now. In FIG. 2B the future peers 43, 45, 47 are currently influential peers to the target 40.

The system may use an ellipse centered on the new locus to set the area of inclusion. Contrasted with semi-circular inclusion area of FIG. 2A, the inclusion area in FIG. 2B is an ellipse (or n-dimensional ellipsoid), as it includes negative distances, i.e. worse attribute values than the new locus. This approach may be computationally simpler than using a semi-sphere and minimums.

As an example, a company in the social media industry may be considering strategic actions to take in the next 1.5 years. The industry's three important attributes are given in FIG. 5 and for this example, assume the growth model indicates an expected annual improvement of 20%, 10%, and −3% respectively. The inclusion range for influential peers for these attributes is ±5%, ±12%, and ±15% respectively. Thus the system identifies influential peers having attributes value within the range:

AttributeRangeₚₑₑᵣ=Attribute_{target}×(1+20%)^{1.5}×(1±5%) Eq. 5

Assuming the target's attribute value are now 10 million views per month, 1 million unique visitors, and 10% bounce rate, their influential peers will have attributes in the range of 13.8-12.5 million views, 1.3-1.0 million unique visitors, and 11.0-8.1% bounce rate.

As shown in FIG. 2C, the system may create an area for inclusion based on the modeled advancement for each attribute in time, starting from the target's attribute values to a point relevant to the business recommendation. The pair of curves define a non-linear area of inclusion based on the distribution of expected advancement. Organizations 45, 47 are deemed influential.

In another embodiment, the system employs heuristic rules to determine influential peers for a target organization in an industry. For example, the rule may be “in the mining industry, in the Western US, companies with at least 10,000 employees will be influenced by companies with revenue greater than $10BN.” The model is created by programming in a plurality of these rules, possibly implemented as a decision tree. *Dave? * move? Delete?*

In one embodiment, the peer agent may determine that the more advanced company is the one with more connections or more connections to advanced companies. For example, the peer agent may determine a first set of companies connected to a first company and compare the total to a second set of companies connected to a second company. Preferably the first and second sets have the same type of relationship (e.g. vendor, client, investor) to the first and second companies. The calculation can be a recursive algorithm, with each organization's strength based on the total strength on its connections, whose strengths are based, in turn, on their connections' strengths.

From identification in the database of peers to a target organization, influential peers can be determined and for each of those, an influence score can be calculated. The score may be binary whereby all organizations within an inclusion area are influential peers, and those without are not influential peers. Alternatively the score may be a balance between the magnitude of advancement of the influential organization and its distance from the target. For example, the influence score my be a utility function, such as: the relative strength of attributes calculated for example by Equations 2 to 4; or inverse to the attribute distance calculated for example by Equations 6.

influencescore=1/(distance+1) Eq 6

, where distance is equal to relative strength of attributes of the influential organization relative to an extrapolation of the target's attribute values. For example, the influence score of organizations 43, 45, 47 in FIG. 2B is the distance from the extrapolated locus 40′.

### Historic Data

In preferred embodiments, the system compares organization using historical data, rather than just static or current values.

The historical data may be categories of developmental stages than can describe an organization. For example, over a period of many years, a company may be describes as: start-up, seed funded, stage A funded to stage n funded, public or ‘Blue Chip’. Similarly the historical data may be descriptions of events of an organization, such as Initial Public Offering (IPO), product launch, and bankruptcy. These temporal values are less precise than daily time stamps, but require less computational resources and may actually be better descriptors of an organization.

In one embodiment, the system maintains a list of possible values of stages and events, having scores or a comparative order. Thus the system can compare the relative advancement of one organization to another to determine which is a peer or influential peer. FIG. 4 is a table of ordered stages and events with a score for each. Thus the system can determine that a stage A funded company will be influenced by a stage B or C funded company because they are more advanced in the development of a business. Similarly the system can determine that a company without a launched product will be influenced by a company with one or two launched products. The influence inclusion area in this example might be set to +two stages or +20 points.

In one embodiment, the system uses fuzzy logic to compare peers and/or make recommendations. Ranges of values for certain attributes are used to categorize present and past stages of an organization. For example, the stage of “start-up” may be categorized by having few employees, a low market capitalization, recent establishment, and no product or service launched.

As a pseudo-code example, the following statement evaluates whether a peer is an influential peer because it was similar at time1 but has grown:

IF (peer_time1 was [start-up] AND peer_time2 is now [public] AND target_time2 is [start-up]) THEN peer is [influential].

The system may also consider peers that are situationally similar. Consider two peers with similar attribute values, each having two product-launch events and only the second peer having a product-recall event. To a target with one product-launch, the first peer is an influential peer but not the second peer. To a target with one product launch and one product-recall event, the second peer may be deemed an influential peer, being situationally similar. Although a recall is bad event and in the table has a negative score, the target organization may improve by following a strategy of a peer that experienced this event and has improved itself.

This shared negative event may be captured by the peer agent by increasing the influence score of the peer organization by the magnitude of the event score if both the target and peer have this event in their historical data.

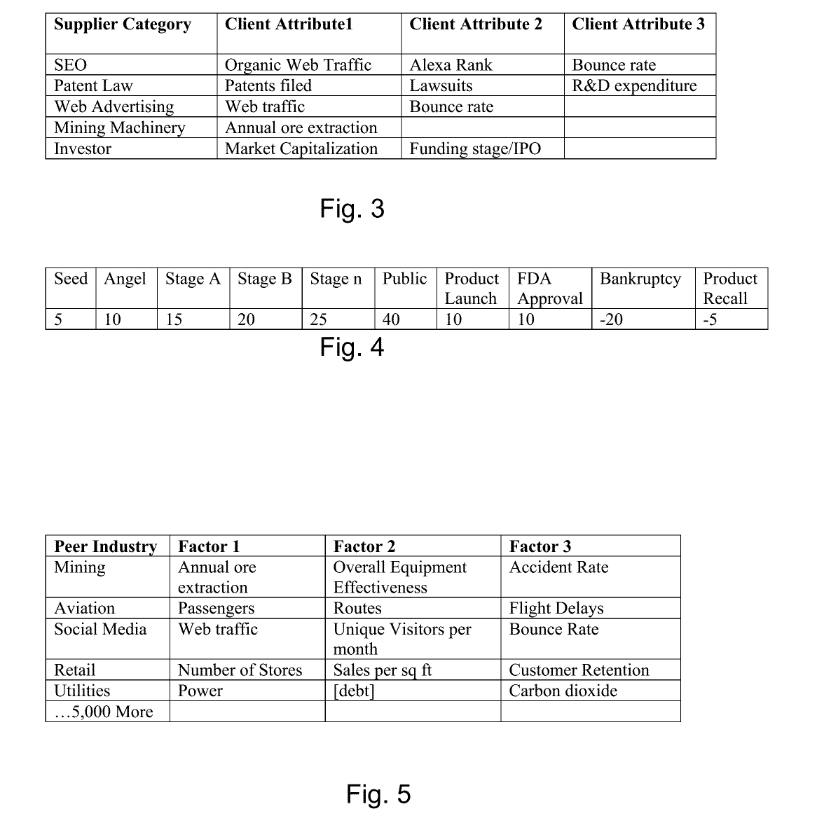

In some embodiments, continuous historical attribute data of peers are compared to the historical attribute data of the target organization. There may be a plurality of attributes to compare, wherein the selection of attributes and weighting of attributes towards a peer score depends on attributes that are most important to the peers' industry or the product or service being searched (see tables of FIGS. 3 and 5).

The time-series analysis technique may be one of: ARIMA, ARCH, Co-integration analysis, cross-correlation signal processing, Level Shifts, Mann-Kendall tests for trends, minimum integrated area, a multiply-trended regression model, or Granger causality. One of the outcomes of the time-series analysis is preferably metrics regarding the degree of similarity between two organization and degree that one is more advanced than the other. This enables the system to determine which peers' attribute values were/are most similar to the target and also improved in one or more of the attributes, preferably in one of the success factors. Such metrics may require modification of some of the above techniques or interpretation of the parameters.

The system may compute the peer score or influence score between organizations (a) offline by considering the attributes most important to the target's industry or (b) in a real-time response to a query by considering the attributes important to the query (and optionally the attributes in (a) as well).

The time-series attribute data may reflect two organizations' co-trends, development, and sensitivity to market changes. For example, several companies may currently have the same attribute value but the companies that advanced at a similar rate will be scored more similar. Some companies may have attributes that are cyclical and the system will try to detect companies whose attributes are in sync, even though the absolute values are quite different.

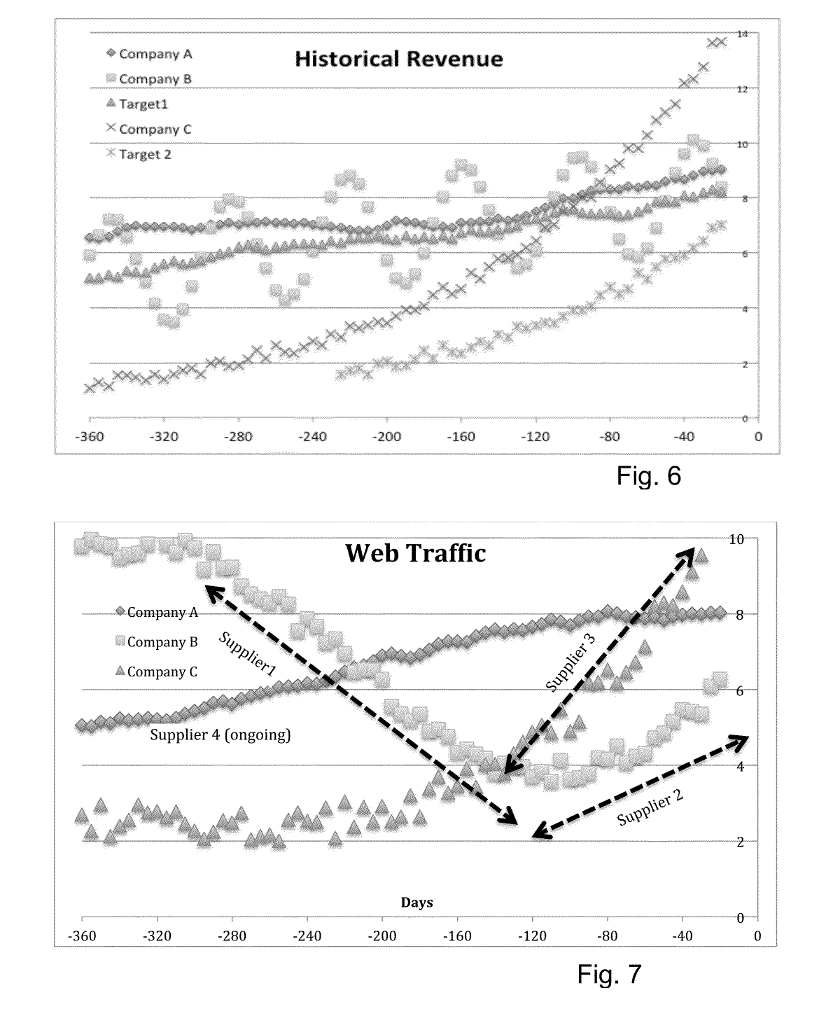

FIG. 6 charts the revenue attribute data for three peer companies over the previous year. Company A had steadily increasing revenue, Company B had oscillating revenue, and Company C had exponentially increasing revenue. The model agent compares the historical data for the Target 1 to the peers' data to determine that Company A is most similar in form to Target 1, although having higher revenue. The system scores Company A as highly similar and an influential organization to Target 1.

The current revenue of Target 2 is less than the others, which could support the supposition that Companies A-C are all influential peers. Using time-series analysis, the system determines that historically Company C's data curve is most similar to Target 2's data curve (both being exponential), whereby Company C can be seen as having consistently higher revenue or leading Target 2 by 220 days. Thus Company C will have the highest influence score with respect to Target 2.

### Recommendation Engine

The system may use data in the database to make recommendations about organizations or business actions for a target organization. The recommendation may be in response to a user-initiated query, a targeted ad or a push-based request from the system itself. A user request to view data from the database may take the form of a search string or selecting a hyperlink or filter button for an attribute or name. The present recommendation engine accepts such requests and returns a set of matching data objects.

The recommendation engine is a system comprising a database, processors, and software to provide a personalized recommendation, preferably of an organization for another organization. For simplicity, in the discussion hereafter, the organizations being sought shall be referred to as suppliers (aka first organizations) and organizations receiving products or services form the suppliers shall be referred to as clients (aka second organizations). This supposes that a user wants to know from which suppliers his organization should buy products or services based on which clients use that supplier and are similar to the user's organization. It will be appreciated that the search is not always directed at finding a supplier of the product or service and that the organizations connected to a suppliers are not always clients in the relationship. It will also be appreciated that the system could be used by an employee, automated search tools or a broker to search on behalf of the target organization.

Using keywords or selecting hyperlinks, the user indicates one or more criteria for the search of products or services, preferably directed to product/service categories or an industry. Whereas size, revenue, and location are examples of attribute data that would not indicate the product or service category, they could be used as criteria to refine the search, either as an input with the product or service criteria or selected during a subsequent step.

In order to personalize the recommendation of first organizations, the engine determines or receives identification data for the target organization. In one embodiment, the engine receives data identifying the user's organization such as name, web domain, email address, IP address, or company registration number, etc. Identification data can be used to determine attributes of the target organization, either with reference to the database or by scraping data from the Internet in real-time. The recommendation engine retrieves from the database, or calculates in real-time, influence scores for second organizations that are connected to the first organizations being sought. The set of matching first organizations are ranked using the influence score of second organization.

The selection agent uses the database of business relationships to select a set of first data objects of products, services, or organizations that satisfy the criteria and retrieves data as required.

The selection agent identifies influential organizations and, for each, identifies relationship data objects indicating that the influential organizations are consumers of the selected product and services to create the set of second organizations. Some of the influential organizations might not consume the matching product and services and are thus irrelevant.

In one embodiment, the engine uses the metric to determine whether each recommended data object is more or less suitable than another to output an ordered set of recommended data objects. In another embodiment, the engine computes the metric as a score for each recommended data object and outputs the recommended data objects according to the scoring.

It is also possible to combine the above methods. For example the engine may calculate a rough score to order the recommended data objects, then perform direct comparisons between close scoring data objects, and then limit the output to only the top ten.

The engine scores or ranks the recommended data objects using the influence score of the influential organizations and/or their spending or rating of first organizations/products/services. These factors and others may be summed, weighted and combined (see equation 9) to get a balanced scoring, or multiplied together (see equation 10) to capture very similar organizations that also spend a lot or highly rate a particular product/service. Equations 7-10 below provide examples for calculating a score for a product/service.

Score1=n Eq. 7

Score2=Σᵢ₌₁ⁿinfluenceᵢ Eq. 8

Score3=C1×Σᵢ₌₁ⁿspendᵢ+C2×Σᵢ₌₁ⁿratingᵢ+C3×Σᵢ₌₁ⁿinfuenceᵢ Eq. 9

Score4=Σᵢ₌₁ⁿinfluenceᵢ×spendᵢ Eq. 10

where Score is the score of a particular product/service/first organization, n is the number of influential organizations connected to a particular product/service/first organization; spend and rating are attributes of the relationship object indicating the amount spent on or rated for a product/service/first organization by each influential organization, influence is the influence score of an influential organization as viewed by the target organization, and C1, C2, C3 are weighting coefficients.

Equation 8 scores product/service based on the total influence score of influential organizations, whilst Equation 7 is simply the number of influential organizations connected in a relevant way to the first organizations.

The skilled person will appreciate that alternative algorithms and weightings may be used to calculate a metric for each supplier within the spirit of the invention and the invention is not intended to be limited to any particular algorithm. The types of data that are retrieved, when they are retrieved, and whether they are cached in local memory for processing will depend on the implementation coded by the skilled programmer. For example, the program may be implemented to identify one second organization, find that organization's first connected product, and retrieve the product data and then repeat for all second organization and their products. Alternatively the program may identify, retrieve and cache all second organization objects, then cache all their consumed product objects, then send all data for the organizations and products to the recommendation engine for scoring.

### Effect on Attributes

An improvement on using influential organization as a signal to recommend first organizations is for the system to determine which attributes of influential organization have been improved by first organizations. The aim is to apportion a second organization's success to the first organizations that could have reasonably contributed to the success. In preferred embodiments, the system comprises a record of attributes that may be affected by using a particular category of service/product/or having a business relationship with first organizations. A first organization may affect more than one attribute and an attribute may be affected by more than one first organization. The affects may be recorded with the individual service/product/organizations data objects in a table for each category of service/product or organization's industry.

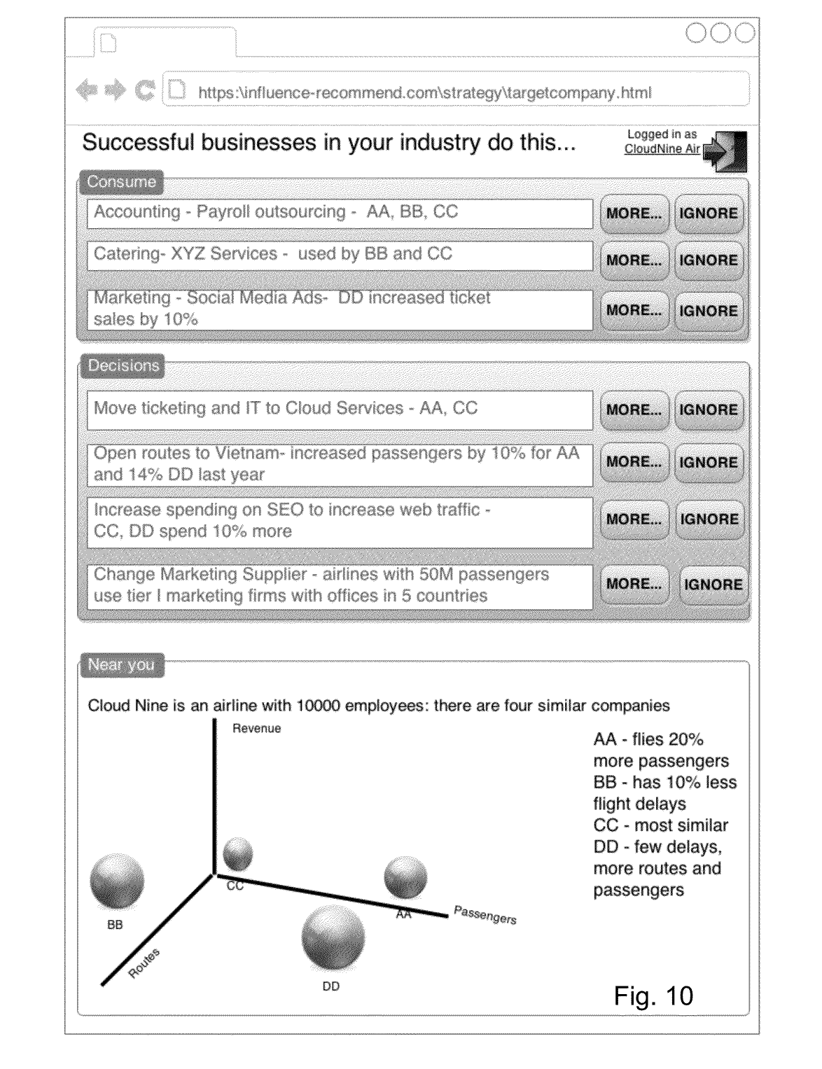

In the example table of FIG. 3, a Search Engine Optimization (SEO) firm is expected to affect their client's web traffic, Alexa™ rank, and bounce rate most, although they may have an indirect affect on revenue too. Other services (e.g. web services) may have a similar effect and of course the client's own efforts can affect their attributes too. Thus a given client's attribute value will be the result of several organizations/services/products and the database will comprise millions of clients whose attributes are affected by millions of connected organizations/services/products. The system comprises an attribute effect agent to estimate the contribution from each organization/service/product towards attribute values. The contribution may be expressed as a percentage or absolute amount of the attribute value. The effect agent may create a model, for example using neural nets or regressions. The model may be used to estimate the average effect that an organization/service/product had on other organizations or estimate the expected advancement that a target organization will get from using a specific or category of organization/service/product. Examples of the effects are displayed in the webpage of FIG. 10.

Historical data as well as static data may be used by the effect agent. FIG. 7 is a chart of historical web traffic data for three companies A, B, C. In addition to the historical attribute data of the client, historical relationship data is recorded in the database such that the system can model the effect a supplier has had on their clients' attributes over time. The suppliers 1-4 that can affect Web traffic are overlaid in the chart. Thus the effect agent can include a period of time that organizations/services/products were in effect as a factor in the model and can output effects in terms of absolute and rate contributions.

Using the table of FIG. 3, the system determines that two categories of suppliers may have an effect and then determines from the relationship database which suppliers supplied companies A B or C, with the effective categories of service, during the relevant time period.

Company A has had higher average web traffic than Company C over the period considered. However, Supplier 3 has only supplied Company C for the last 130 days during which there was large increase in web traffic resulting in a higher current web traffic value. Company B has used Supplier 1 and Supplier 2 corresponding to negative and positive growth in web traffic. The effect agent can estimate the average effect on the attribute of each supplier and the second organization itself. Inputting the absolute values and growth rates into the effects model, the recommendation engine ranks the suppliers (from best to worst) as Supplier 3, Supplier 2, Supplier 4, then Supplier 1.

The recommendation engine can use the effect agent to recommend one or more organizations/services/products depending on their expected and past contributions. The recommendation may result form a user-query to find first organizations or to improve particular attributes of their target organization. The score or rank of the first organizations will depend on their modeled effect and the similarity of the second organization to the target organization. In preferred embodiments the recommendation engine ranks and displays first organizations that supply influential organizations.

### Displaying Data

Depending on the request form the user, the present system may output data related to the influential organizations, products/services/organizations having a business relationship with the influential organizations, or strategic actions that were successful for the influential organizations. A subset of categories is communicated to the user to advise them of products and services or the relevant organizations. The communication may be to a smartphone app, targeted web ad, or a results page on a website maintained by the present system. The website user interface (UI) provides means for the user to ignore or investigate the products, services, organizations or strategic decisions of influential organizations.

FIG. 10 is a webpage showing attribute and identity data from data objects and values from calculations. The webpage provide data about categories of recommended first organizations/product/services such as: profile data, keywords, identity, attributes and brand names; influential companies to the target organization that consume the relevant product and services; strategic decisions made by influential organizations and the effect on important attributes; and/or an infographic showing the influential organization with respect to the target organization. Preferably the data to communicate are selected based on the score or rank of the recommendation. The webpage provide links to each organization for the user to find out more.

FIG. 10 indicates that companies AA, BB, CC, and DD are similar but more advanced, and thus influential, to the target, Cloud Nine airways. The advancement of each influential company is shown visually in the 3D chart, relative to the target's attributes represented by the chart origin. Above the chart, the consumption and decisions of these influential companies are shown, optionally with an effect on attributes noted.

The serialization agent uses data from the subset of recommended data objects to form the communicated content. This agent serializes the data in a format readable by the client-computer or phone and communicates said content, over a network, to the client-computing device of the user.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” between alternatives is to be understood in the inclusive sense, whereby either alternative and both alternatives are contemplated or claimed. As a short-hand, a slash (“/”) is also used in the inclusive sense, for example to indicate that “products and services” or “products or services” are considered.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

What is claimed is:

1. A computer implemented method for identifying an influential organization from a database of organizations, the method comprising:
a processor receiving, from a database, attribute data of a target organization and attribute data of a second organization;
a processor identifying one or more attributes for comparing organizations and identifying a direction of advance for each attribute;
a processor applying an algorithm to determine that the second organization is an influential organization to the target organization if the attribute values of the second organization are more advanced than the attribute values of the target organization.

2. The method of claim 1, further comprising repeating steps of the method for a plurality of second organizations to determine a set of second organizations that are influential to the target organization.

3. The method of claim 1, wherein identifying the one or more attributes for comparison comprises determining an industry of the target organization and attributes for measuring organizations in the industry.

4. The method of claim 1, wherein the target and second organization are in the same industry.

5. The method of claim 1, wherein the second organization is determined not to be an influential organization if any of its attribute values are more advanced than a threshold amount compared to the target organization.

6. The method of claim 1, wherein the algorithm comprises extrapolating attribute values of the target organizations and calculating a distance from extrapolated attribute values to the second organization's attribute values.

7. The method of claim 1, further comprising calculating an influence score of the second organization from a distance of the second organization's attribute values to the target organization's attribute values.

8. The method of claim 2, further comprising calculating influence scores for the set of influential organizations and ranking them based on the influence scores.

9. The method of claim 1, further comprising calculating advancement of organizations from a projection of their attribute values onto a pre-determined vector of advancement for an industry of the target organization.

10. The method of claim 1, further comprising recording in the database whether the second organization is influential to the target organization.

11. The method of claim 2, further comprising identifying third organizations connected in the database to the set of influential organizations and recommending the third organization to a user.

12. A computer implemented method for identifying an influential organization from a database of organizations, the method comprising:
retrieving historical attribute data of a target organization;
retrieving historical attribute data of a second organization;
identifying one or more attributes for comparing organizations and a direction of advance for each attribute;
a processor applying a time-series analysis algorithm to determine that the second organization is an influential peer of the target organization if the historical attribute values of the second organization are similar but more advanced than the attribute values of the first organization.

13. The method of claim 12, wherein the determination that a second organization is influential further requires that the second organization's attribute values were previously similar to the recent attribute values of the target organization and have subsequently advanced.

14. The method of claim 12, further comprising calculating an influence score for the second organization based on an degree of similarity between the organizations' attribute data and a degree of advancement in the second organization's attribute values.

15. The method of claim 12, wherein a period of the historical attribute data for comparison the depends on a user-query of a category of products or services, the period preferably being greater than 6 months ago or less than 2 years ago.

16. A computer-implemented method for recommending organizations from a database of business relationships between organizations, the method comprising:
a processor receiving a query for searching for first organizations on behalf of a target organization;
a processor determining second organizations that are influential organizations to the target organization;
a processor identifying first organizations from the database that match the query and have a business relationship in the database with at least one of the influential organizations; and
a processor communicating data about the identified first organizations to a client-computing device.
